(19) United States
(12) Patent Application Publication
(10) Pub. No.: US 2024/0298605 A1
(43) Pub. Date: Sep. 12, 2024

(54) EXPANDABLE KENNEL

(71) Applicant: Sam Miranda, Dinuba, CA (US)

(72) Inventor: Sam Miranda, Dinuba, CA (US)

(21) Appl. No.: 18/118,589

(22) Filed: Mar. 7, 2023

(51) Int. Cl. A01K 1/03

(52) U.S. Cl. CPC A01K 1/03; A01K 1/034

(57) ABSTRACT

An expandable kennel apparatus for containing a canine in an enclosed area with an adjustable size includes a housing configured for holding a canine. The housing has a length dimension, a height dimension, and a width dimension, and the width dimension is selectably shortened or elongated to facilitate different sized canines. The housing has a front side having a door positioned therein for accessing an interior of the housing.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to expandable kennel and more particularly pertains to a new expandable kennel for containing a canine in an enclosed area with an adjustable size.

### (2) Description of Related Art Including Information Disclosed Under 37 CFR 1.97 and 1.98

The prior art provides several examples of kennels which are expandable to accommodate different sizes of canine or to provide more room for the canine to move within the kennel. Some expandable kennels in the prior art have wall panels which are slidable with respect to each other to lengthen or shorten the kennel. Others include a collapsible cover such as a netting which allows the kennel to length or shorten. However, the prior art does not disclose an expandable kennel with a telescoping frame and a collapsible cover extending around the telescoping frame. Such a device is desirable in that it provides rigidity from the telescoping frame while combining the rigid frame with a flexible, collapsible cover for securing the canine within the interior of the kennel.

### BRIEF SUMMARY OF THE INVENTION

An embodiment of the disclosure meets the needs presented above by generally comprising a housing configured for holding a canine. The housing has a length dimension, a height dimension, and a width dimension, and the width dimension is selectably shortened or elongated to facilitate different sized canines. The housing has a front side having a door positioned therein for accessing an interior of the housing.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of an expandable kennel apparatus according to an embodiment of the disclosure.

FIG. 2 is a top front side perspective view of an embodiment of the disclosure.

FIG. 3 is a top front side perspective view of an embodiment of the disclosure with walls of a housing removed.

FIG. 4 is a top frond side perspective view of an embodiment of the disclosure.

FIG. 5 is a top front side perspective view of an embodiment of the disclosure with walls of a housing removed.

FIG. 6 is a cross-sectional view of an embodiment of the disclosure taken from Arrows 6-6 in FIG. 3.

FIG. 7 is an in-use view of an embodiment of the disclosure.

### DETAILED DESCRIPTION OF THE INVENTION

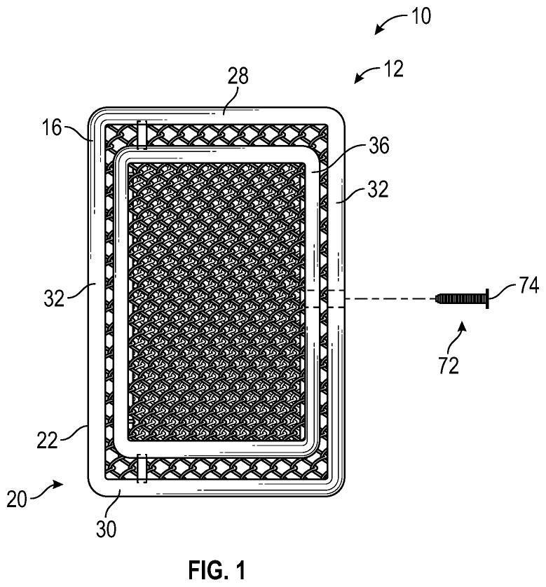

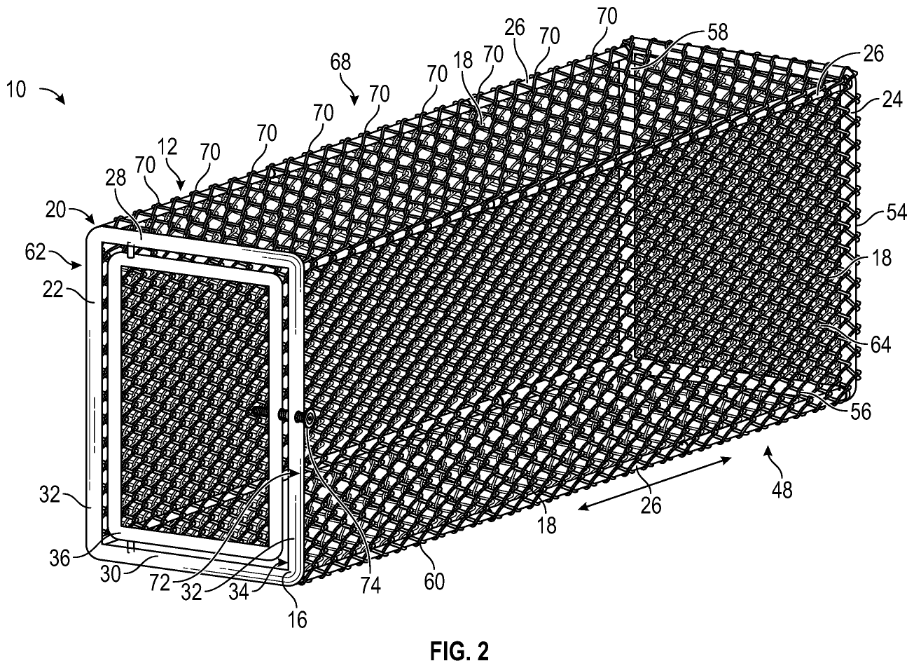

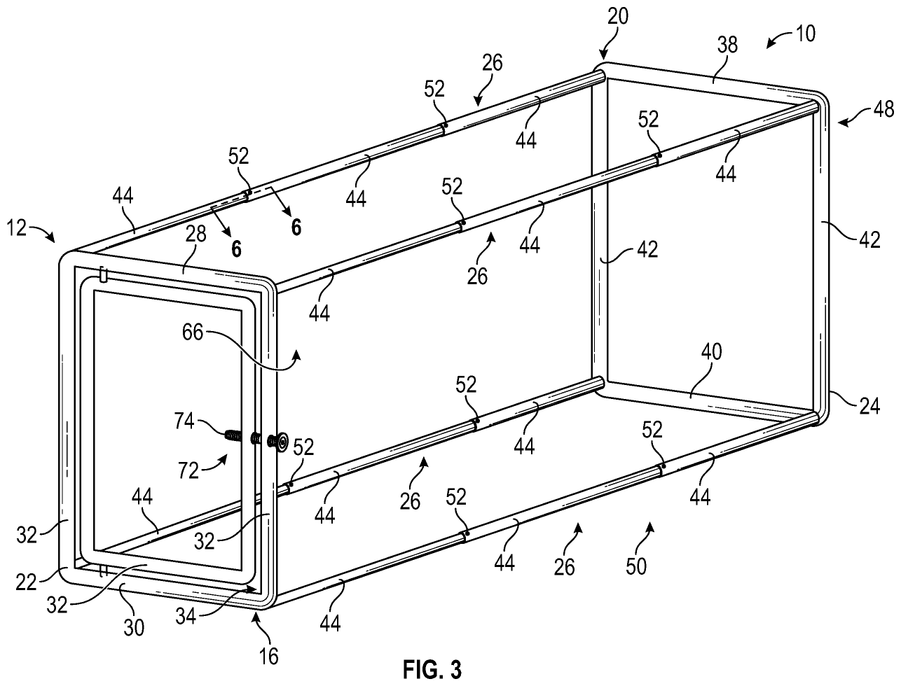

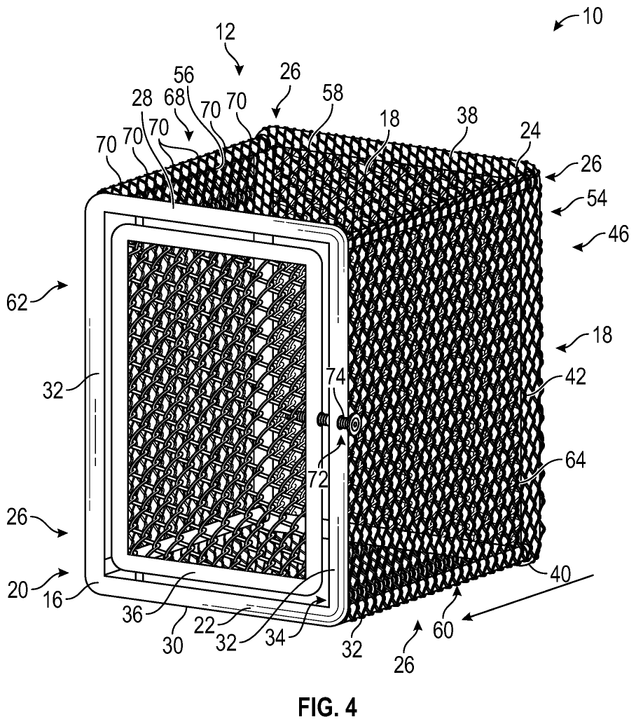

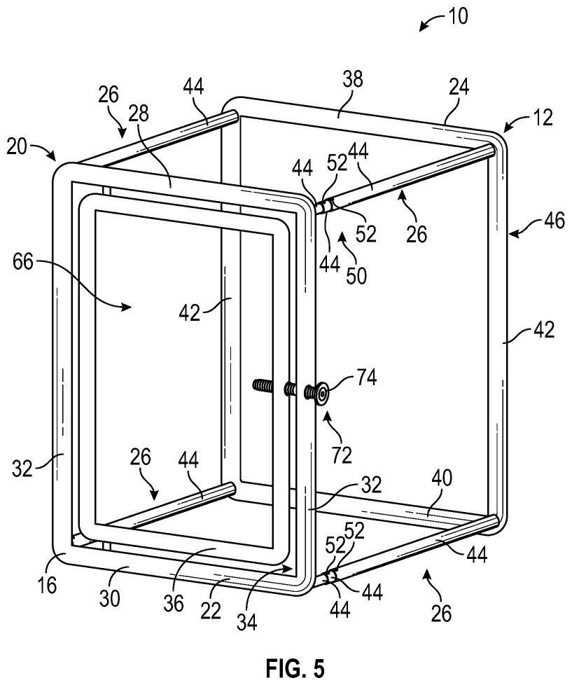

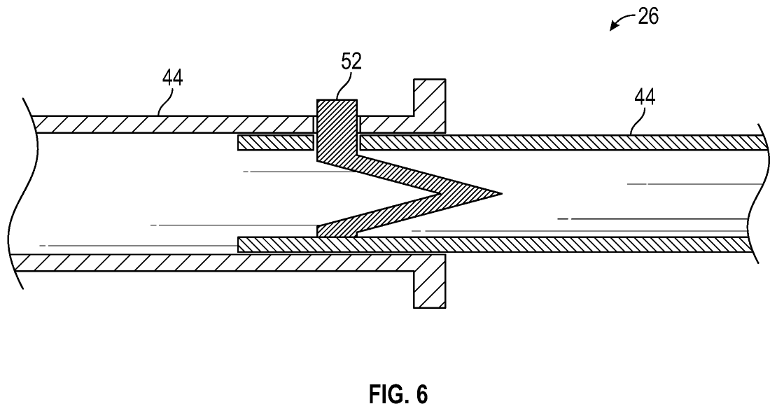

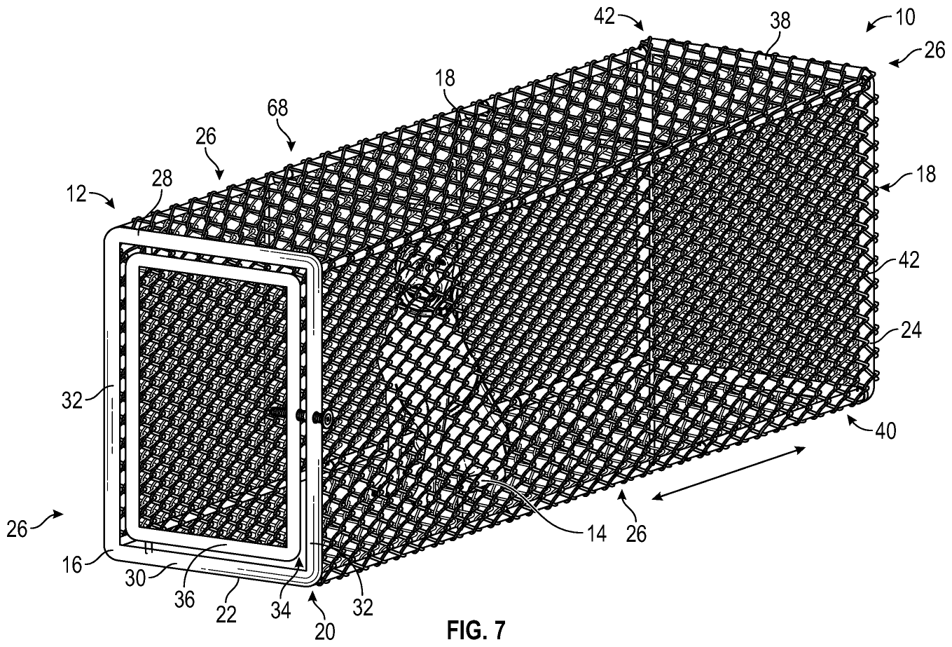

With reference now to the drawings, and in particular to FIGS. 1 through 7 thereof, a new expandable kennel embodying the principles and concepts of an embodiment of the disclosure and generally designated by the reference numeral 10 will be described.

As best illustrated in FIGS. 1 through 7, the expandable kennel apparatus 10 generally comprises a housing 12 configured for holding a canine 14. The housing 12 has a length dimension, a height dimension, and a width dimension, the width dimension is selectably shortened or elongated to facilitate different sized canines 14. The housing 12 has a front side 16 with a door 36 positioned therein for accessing an interior 66 of the housing 12. The housing 12 has a plurality of walls 18 which are movable with respect to each other such that the width dimension is selectably shorten or elongated. The walls 18 may be removable from each other, be arranged to slide past each other, or be foldable with respect to each other in order to shorten and elongate the width dimension.

The housing 12 also includes a frame 20 which comprises a front portion 22, a rear portion 24, and a plurality of telescopic members 26. The front portion 22 includes a top support 28, a bottom support 30, and a pair of side supports 32. The top support 28 and the bottom support 30 are coupled to and extend between the pair of side supports 32. The front portion 22 bounds an opening 34. The door 36 is coupled to the frame 20 and is positionable to cover the opening 34 of the front portion 22. The door 36 is pivotal with respect to the front portion 22. The rear portion 24 includes an upper support 38, a lower support 40, and a pair of lateral supports 42. The upper support 38 and the lower support 40 are coupled to and extend between the pair of lateral supports 42. The plurality of telescopic members 26 is coupled to and extends between the front portion 22 and the rear portion 24. Each telescopic member 26 comprising a plurality of rods 44 which are slidably interconnected. The rear portion 24 is movable between a retracted position 46 and an extended position 48 with respect to the front portion 22. A length between the front portion 22 and the rear portion 24 is between 1.5 feet and 2.5 feet when the rear portion 24 is in the retracted position 46 and between 5.5 feet and 6.5 feet when the rear portion 24 is in the extended position 48.

A retainer 50 is coupled to the frame 20 for securing the rear portion 24 in the extended position 48. The retainer 50 comprises a plurality of locking pins 52, each of which is associated with a pair of adjacent rods 44 of the plurality of rods 44 of one of the plurality of telescopic members 26. Each locking pin 52 is biased to extend through each rod 44 of the associated pair of adjacent rods 44 when the rear portion 24 is in the extended position 48.

The plurality of walls 18 of the housing 12 includes a rear wall 54 and a perimeter wall 56. The rear wall 54 is coupled to the rear portion 24 of the frame 20, extending between the upper support 38 and the lower support 40 and between the pair of lateral supports 42. The perimeter wall 56 is coupled to the frame 20 and extends between the front portion 22 and the rear portion 24 of the frame 20. The perimeter wall 56 and the rear wall 54 partially enclose the interior 66 of the housing 12. The perimeter wall 56 includes a top wall 58, a bottom wall 60, a first side wall 62 and a second side wall 64, and the interior 66 is accessed through the opening 34 of the front portion 22 of the frame 20. The perimeter wall 56 contracts and expands with a contraction and expansion of the frame 20. The perimeter wall 56 comprises chain link fencing 68 with a plurality of links 70, each link 70 of which is movable with respect to an adjacent link 70 of the plurality of links 70 such that the perimeter wall 56 expands when the rear portion 24 is moved toward the extended position 48 and retracts when the rear portion 24 is moved toward the retracted position 46. The perimeter wall 56 also surrounds the plurality of telescopic members 26.

A lock 72 is also provided and is operable to secure the door 36 closed, the lock 72 comprising an insertion pin 74 is insertable through the door 36 and the housing 12 to secure the door 36 closed.

In use, the width dimension is elongated or shortened to a selected size, and the canine 14 is positioned in the interior 66 of the housing 12 to contain the canine 14. The retainer 50 may be used to secure the rear portion 24 in the extended position 48, and the lock 72 may secure the door 36 closed.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An expandable kennel apparatus comprising a housing configured for holding a canine, the housing having a length dimension, a height dimension, and a width dimension, the width dimension being selectably shortened or elongated to facilitate different sized canines, the housing having a front side having a door therein for accessing an interior of the housing.

2. The apparatus of claim 1, further comprising a lock being operable to secure the door closed.

3. The apparatus of claim 2, wherein the lock comprises an insertion pin being insertable through the door and the housing to secure the door closed.

4. The apparatus of claim 1, wherein the housing comprises:
a frame comprising:
a front portion bounding an opening, the door being coupled to the frame and being positionable to cover the opening of the front portion, the door being pivotally coupled to the front portion;
a rear portion;
a plurality of telescopic members being coupled to and extending between the front portion and the rear portion; and
the rear portion being movable between a retracted position and an extended position with respect to the front portion;
a rear wall being coupled to the rear portion of the frame; and
a perimeter wall being coupled to the frame and extending between the front portion and the rear portion of the frame, the perimeter wall and the rear wall partially enclosing the interior of the housing, the interior being accessed through the opening of the front portion of the frame, the perimeter wall contracting and expanding with a contraction and expansion of the frame.

5. The apparatus of claim 4, wherein:
the front portion includes a top support, a bottom support, and a pair of side supports, the top support and the bottom support being coupled to and extending between the pair of side supports;
the rear portion includes an upper support, a lower support, and a pair of lateral supports, the upper support and the lower support being coupled to and extending between the pair of lateral supports;
the rear wall extends between the upper support and the lower support and between the pair of lateral supports; and
the perimeter wall including a top wall, a bottom wall, a first side wall and a second side wall.

6. The apparatus of claim 4, wherein each telescopic member comprises a plurality of rods, the plurality of rods being slidably interconnected.

7. The apparatus of claim 4, wherein a length between the front portion and the rear portion being between 1.5 feet and 2.5 feet when the rear portion is in the retracted position, the length between the front portion and the rear portion being between 5.5 feet and 6.5 feet when the rear portion is in the extended position.

8. The apparatus of claim 4, wherein the perimeter wall comprises chain link fencing having a plurality of links, each link of the plurality of links being movable with respect to an adjacent link of the plurality of links such that the perimeter wall expands when the rear portion is moved toward the extended position and retracts when the rear portion is moved toward the retracted position.

9. The apparatus of claim 4, wherein the perimeter wall surrounds the plurality of telescopic members.

10. The apparatus of claim 4, further comprising a retainer being coupled to the frame for securing the rear portion in the extended position.

11. The apparatus of claim 6, further comprising further comprising a retainer being coupled to the frame for securing the rear portion in the extended position, the retainer comprising a plurality of locking pins, each locking pin of the plurality of locking pins being associated with a pair of adjacent rods of the plurality of rods of one of the plurality of telescopic members, each locking pin being biased to extend through each rod of the associated pair of adjacent rods when the rear portion is in the extended position.

12. An expandable kennel apparatus comprising:
a housing configured for holding a canine, the housing having a length dimension, a height dimension, and a width dimension, the width dimension being selectably shortened or elongated to facilitate different sized canines, the housing having a front side having a door therein for accessing an interior of the housing, the housing comprising:
a frame comprising:
a front portion including a top support, a bottom support, and a pair of side supports, the top support and the bottom support being coupled to and extending between the pair of side supports, the front portion bounding an opening, the door being coupled to the frame and being positionable to cover the opening of the front portion, the door being pivotally coupled to the front portion;
a rear portion including an upper support, a lower support, and a pair of lateral supports, the upper support and the lower support being coupled to and extending between the pair of lateral supports;
a plurality of telescopic members being coupled to and extending between the front portion and the rear portion, each telescopic member comprising a plurality of rods, the plurality of rods being slidably interconnected; and
the rear portion being movable between a retracted position and an extended position with respect to the front portion, a length between the front portion and the rear portion being between 1.5 feet and 2.5 feet when the rear portion is in the retracted position, the length between the front portion and the rear portion being between 5.5 feet and 6.5 feet when the rear portion is in the extended position;
a rear wall being coupled to the rear portion of the frame, the rear wall extending between the upper support and the lower support and between the pair of lateral supports;
a perimeter wall being coupled to the frame and extending between the front portion and the rear portion of the frame, the perimeter wall and the rear wall partially enclosing the interior of the housing, the perimeter wall including a top wall, a bottom wall, a first side wall and a second side wall, the interior being accessed through the opening of the front portion of the frame, the perimeter wall contracting and expanding with a contraction and expansion of the frame, the perimeter wall comprising chain link fencing having a plurality of links, each link of the plurality of links being movable with respect to an adjacent link of the plurality of links such that the perimeter wall expands when the rear portion is moved toward the extended position and retracts when the rear portion is moved toward the retracted position, the perimeter wall surrounding the plurality of telescopic members;
a retainer being coupled to the frame for securing the rear portion in the extended position, the retainer comprising a plurality of locking pins, each locking pin of the plurality of locking pins being associated with a pair of adjacent rods of the plurality of rods of one of the plurality of telescopic members, each locking pin being biased to extend through each rod of the associated pair of adjacent rods when the rear portion is in the extended position; and
a lock being operable to secure the door closed, the lock comprising an insertion pin being insertable through the door and the housing to secure the door closed.
